(19) United States
(12) Patent Application Publication
(10) Pub. No.: US 2022/0044267 A1
(43) Pub. Date: Feb. 10, 2022

(54) DYNAMIC DATA ATTRIBUTION OF POINTS OF INTEREST

(71) Applicant: THE STABLE GROUP, LLC, MINNEAPOLIS, MN (US)

(72) Inventors: Mark von Oven, Chanhassen, MN (US); Stephen Ripple, St. Paul, MN (US); Andrew Olson, St. Paul, MN (US)

(21) Appl. No.: 17/394,029

(22) Filed: Aug. 4, 2021

Related U.S. Application Data
(60) Provisional application No. 63/060,923, filed on Aug. 4, 2020.

(51) Int. Cl. G06Q 30/02; G06Q 50/26; G06F 16/29

(52) U.S. Cl. CPC G06Q 30/0205; G06F 16/29; G06Q 30/0201; G06Q 50/26

(57) ABSTRACT

Dynamic data attribution of a point of interest (POI) includes utilizing the latitude and longitude of a specific POI, along with a population density associated with a zip code in which the POI resides, to define a geographical area for which publicly and/or privately developed data attributes exist and are retrievable. Retrieved data attributes are stored in association with the POI for subsequent data analysis. In certain embodiments, the retrieved data attributes are analyzed to inform decisions related to products and/or services that are offered at the POI.

### CROSS-REFERENCE TO RELATED APPLICATIONS

This application claims the benefit of U.S. Provisional Patent Application No. 63/060,923, filed Aug. 4, 2020, entitled, “DYNAMIC DATA ATTRIBUTION OF BRICK AND MORTAR POINTS OF INTEREST.” The disclosure of this priority application is hereby incorporated by reference in its entirety into the present application.

### TECHNICAL FIELD

The present disclosure relates to computer-based data attribution and, more particularly, to computer-based systems and methods for dynamic data attribution of points of interest.

### BACKGROUND OF THE INVENTION

The computerized world has generated a multitude of data on virtually every conceivable notion. This data can be analyzed for patterns or trends to inform future decision-making. However, decision-making is only well-informed if the data under analysis is pertinent to the decision at hand. Accordingly, an appropriate selection of data to analyze is an important first step in obtaining insight for the future from the past.

### SUMMARY OF THE INVENTION

The present disclosure is directed to the selection of pertinent data. More specifically, the present disclosure is directed to dynamic data attribution of points of interest (POI). Dynamic data attribution of POI includes utilizing the latitude and longitude of a specific POI, along with a population associated with a zip code in which the POI resides, to define a geographical area for which publicly and/or privately developed data attributes exist and are retrievable. Retrieved data attributes are stored in association with the POI for subsequent data analysis. In certain embodiments, the retrieved data attributes are analyzed to inform decisions related to products and/or services that are provided at the POI.

In certain aspects, the present disclosure is directed to a computer-implemented method for data attribution that includes: (a) obtaining a latitude and longitude of a first point associated with a physical location of a point of interest; (b) determining a first zip code in which the point lies; (c) determining a population density of the first zip code; (d) establishing a geographical circle about the point of interest with the point located at the center of the geographical circle, the geographical circle having a distance radius, measured relative to the center, that is inversely proportional to the population density of the first zip code; (e) determining a second zip code with which the geographical circle intersects; (f) obtaining data attributes associated with the first and second zip codes; and (g) associating the data attributes with the point of interest.

In certain aspects, determining the second zip code includes: (a) obtaining a latitude and longitude of a second point, the second point being at a physical location previously established as an identifying location of the second zip code; (b) determining a distance between the first point and the second point; and (c) determining that the distance less than or equal to the distance radius. In certain aspects, determining the distance between the first and second points includes utilizing Haversine distance formula.

In certain aspects, the data attributes associated with the first and second zip codes are obtained from a publicly-accessible database. In certain aspects, the data attributes of the publicly-accessible database have been generated from census data obtained by state or country in which the point of interest lies.

In certain aspects, the computer-implemented method for data attribution further includes: (a) obtaining data attributes specific to a functionality of the point of interest; and (b) combining and storing the data attributes specific to the functionality of the point of interest with the data attributes associated with the first and second zip codes. The computer-implemented method can further include analyzing the combined data attributes to inform a decision on offering a certain product or service at the point of interest.

In certain aspects, the computer-implemented method for data attribution further includes: (a) obtaining a latitude and longitude of a new point associated with a physical location of a second point of interest, the new point being different from the first point; (b) determining a new zip code in which the new point lies; (c) obtaining data attributes associated with the new zip code; and (d) combining and storing the data attributes associated with the new zip code with the data attributes associated with the first and second zip codes. The physical location of the second point of interest can be inside or outside the geographical circle.

In certain aspects, the present disclosure is directed to a computer-implemented method for data attribution that includes: (a) defining a geographical area equidistantly about a physical location of a point of interest, the physical location associated with a first zip code; (b) determining that the geographical area intersects with a physical location associated with a second zip code that is different from the first zip code; (c) obtaining data attributes associated with the first and second zip codes; and (d) associating the data attributes with the point of interest.

In certain aspects, the present disclosure is directed to a computer-implemented method for data attribution that includes: (a) defining a geographical area equidistantly about a physical location of a point of interest, the physical location associated with a first zip code; (b) determining that the geographical area intersects with a physical location associated with a second zip code that is different from the first zip code; (c) obtaining first data attributes associated with the first and second zip codes; (d) obtaining second data attributes associated with a functionality of the point of interest; (e) combining the first and second data attributes; (f) associating the combined first and second data attributes with the point of interest; and (g) analyzing the combined first and second data attributes to inform a decision on offering a product or service at the point of interest.

### BRIEF DESCRIPTION OF THE DRAWINGS

FIG. 1 illustrates dynamically generated geographical areas for various points of interest according to the present disclosure.

FIGS. 2A-2B provide a comparison illustration of attributes when considering attributes associated with a zip code in which a point of interest lies, FIG. 2A, and when considering attributes associated with a dynamically generated geographical area for the point of interest, FIG. 2B.

FIG. 3 illustrates the geographical areas of FIG. 1 along with secondary points of interest.

FIG. 4 illustrates an example environment in which aspects of dynamic data attribution of points of interest can be practiced.

FIG. 5 illustrates a flowchart of an example method for dynamic data attribution of points of interest.

FIG. 6 is an example configuration of a computer-based user-interface for implementing aspects of the method for dynamic data attribution of points of interest.

FIG. 7 is example computing device that can be used in performing aspects of dynamic data attribution of points of interest.

### DETAILED DESCRIPTION

Various embodiments are described in detail with reference to the drawings. The description of the various embodiments is not intended to limit the scope of the claims attached hereto. Further, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. For example, the term “including” shall mean “including, but not limited to.” The term “such as” also is not intended to be limiting.

Dynamic data attribution of points of interest (POI) includes utilizing the latitude and longitude of a specific POI, along with a population density associated with a zip code in which the POI resides, to define a geographical area for which publicly and/or privately developed data attributes exist and are retrievable. More specifically, the latitude and longitude of the specific POI are established as the center point of a geographical circle having a radius that is inversely proportional to the population density associated with the zip code in which the POI lies. Accessible data attributes that are associated with the zip code of the POI, as well as accessible data attributes that are associated with zip codes that intersect the geographical circle, are retrieved from one or more data storage devices and stored in association with the POI for subsequent data analysis. In certain embodiments, the retrieved data attributes are analyzed to inform decisions related to products and/or services that are provided at the POI.

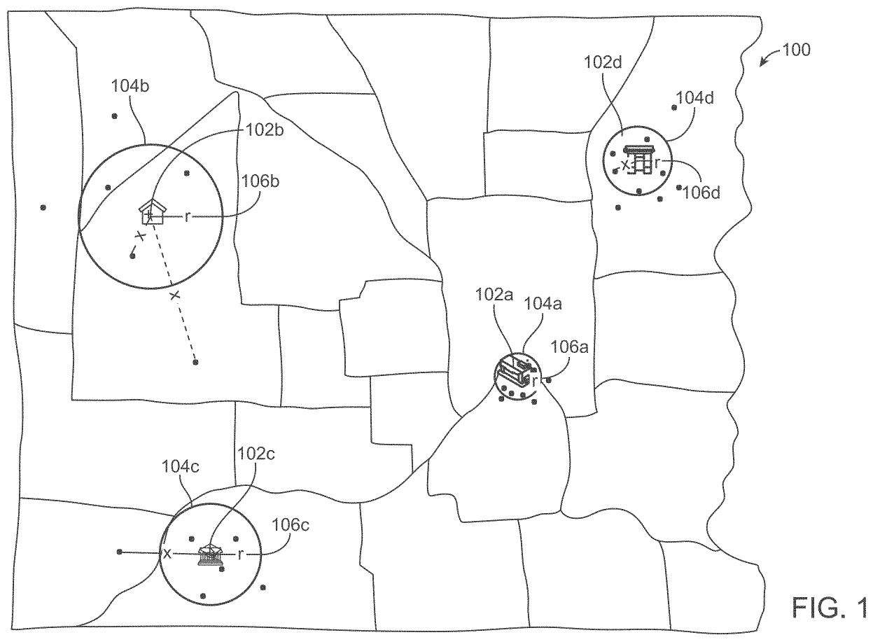

Referring to FIG. 1, a geographical map 100 illustrates various points of interest, hereafter POI, such as a retail store 102a, a hospital 102b, a college 102c and a gymnasium 102d; other POIs are also possible. Note that a point of interest may comprise, for example, a building a statue, a park, a vacant lot, or any specific point location on the earth. Each of the POIs 102a-102d has a position point on the map 100 that is identified with a unique latitude and longitude. Each of the POIs can additionally be identified as residing within a specific zip code based on the latitude/longitude. In certain embodiments, the zip code of each of the POIs 102a-102d can be determined, alternatively or additionally, from a street address of the respective POI 102a-102d.

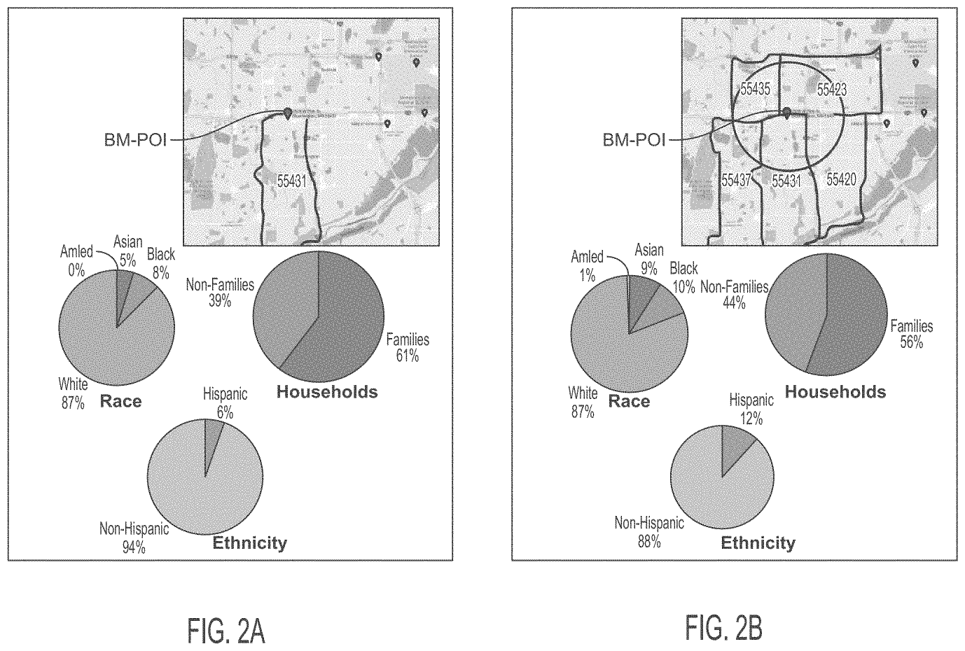

A geographical circle 104a, 104b, 104c, 104d surrounds each respective POI 102a-102d, with the POI 102a-102d comprising the center point of the geographical circle 104a-104d. The geographical circle 104a-104d is defined by a distance radius (r), from the center point to outward edge 106a-106d of the geographical circle 104a-104d. The distance radius (r) is inversely proportional to the population density of the zip code in which the POI 102a-102d lies. The use of an inversely proportional distance radius (r), e.g., a smaller radius for a more dense population and a larger radius for a less dense population, is based on the proposition that in densely populated areas a person may be less likely to visit the POI than in a lower-density area. The geographical circle 104a-104d may lie entirely within a single zip code or may intersect with other zip codes. Note that on FIGS. 1 and 2 unique zip codes lying within or outside the geographical circle 104a-104d are indicated with a dot.

The inversely proportional distance radius (r) may be defined using a predetermined thresholding. For example, for all POI, there may be a particular location associated with a highest surrounding population density, and another location having a lowest surrounding population density. In example embodiments, the radius distance for these extreme cases may be set, and the inverse proportion may be defined between those thresholds, thereby defining the side of a respective geographic circle (e.g., geographic circles 104a-d).

Whether the respective geographical circle 104a-104d intersects with another zip code is based on whether a latitude and longitude point of a respective zip code is of a distance (x) from the MB-POI that is equal to or less than the determined distance radius (r), e.g., x≤r. In certain embodiments, the distance x is determined using the Haversine formula. The Haversine formula determines the great-circle distance between two points on a sphere (e.g., Earth) given their latitudes and longitudes.

The zip code in which the POI 102a-102d lies as well as all other zip codes with which the respective geographical circle 104a-104d intersects are associated with the corresponding POI 102a-102d as a collective listing of zip codes. In some instances, the collective listing of zip codes is limited to those zip codes for which a centroid of the zip code falls within the geographic circle 104a-104d of the respective POI 102a-102d. In other embodiments, the zip code can be included so long as some predetermined portion (or portion of the population) of that zip code falls within the respective geographic circle 104a-104d.

In certain embodiments, attributes that have been previously associated with zip codes of the collective listing are obtained and analyzed to infer future options for future offering of certain products and/or services within the respective geographical circle 104a-104d. For example, in the instance of the retail store 102a being at the center of the geographical circle 104a, an analysis as to high-performing sales or lower-performing sales across related or unrelated retail entities having similar characteristics (e.g., being near other points of interest, or within particular demographic groups for customers within the geographical circle 104a) can be performed to identify items or services that are likely to be of interest to customers likely to shop at the primary point of interest, e.g., the POI 102a. In certain embodiments, all information (e.g., radius (r), distances (x) from the POI to other zip codes) and attributes for the collective list of zip codes is combined into a single record of information which is attributed to and stored with an identification (e.g., latitude/longitude, street address, or other suitable identifier) of the POI for analysis.

Attributes can include, for example: (a) demographic information such as age, gender race, marital status, number of children, occupation, annual income, education level, living status (e.g., homeowner/renter), marriage, birth and death rates, vehicle registrations; and/or (b) usage data such as internet usage data (meta-data of topic searches, websites accessed, time spent on websites, e-retail data), utility usage data; and/or (c) sales data such as type and/or quantity of retail and/or e-retail products sold and/or returned, and/or type and/or quantity of services sold. Of course, any number of other attributes associated with the various zip codes within the collective listing of zip codes can also be used for identifying items or services that are likely to be of interest to customers residing and/or working in the zip codes of the collective listing.

In certain embodiments, analysis of attributes is not limited to identifying items or services, but can be utilized for any purpose of interest such as community planning (e.g., how many homes, schools, hospitals should be built), environmental impacts, labor markets, prospective business location, etc. Other examples wherein of dynamic data attribution of POI analysis can be used include: real estate (e.g., residential information disclosures or commercial property selection for restaurants/businesses); campaign strategies (e.g., ranking locations for optimal candidate appearances based on desired demographics); recruitment (e.g., membership drives for churches, gyms, races, employment); and insurance rates (e.g., adjustments based on certain POI being within or outside of the radius).

In certain embodiments, attributes associated with the collective listing of zip codes can be combined with attributes specifically attributed to the POI. For example, in the instance of the retail store 102a, attributes can include sales data and/or customer demographics tracked by the retail store. In the instance of the hospital 102b, attributes can include, for example, drugs/products inventoried on-site, procedure costs, and patient demographics tracked by the hospital. In the instance of the college 102c, attributes can include, for example, tuition payments received, faculty salaries and/or student demographics tracked by the college. In the instance of the gymnasium 102d, attributes can include, for example, gym fees received, facility usage, and/or client demographics. The noted attributes are but a few of the numerous attributes that are specific to the functionality of the POI and can be used for analysis in combination with the known attributes associated with the zip codes of the collective listing.

FIGS. 2A-2B provides a comparative illustration of how attributes associated with a POI can differ when based strictly on a zip code associated with the POI, see FIG. 2A and when based on combined attributes of the zip codes that lie within the distance radius (r) that is inversely proportional to the population density of the zip code of the POI, see FIG. 2B. As shown in FIG. 2A, the attributes associated only with the zip code in which the POI lies provides race attributes of: (a) 87% White; (b) 8% African American (Black); (c) 5% Asian; and (d) 0% Native American (AmInd). FIG. 2A also provides household attributes of 39% non-Families and 61% Families as well as ethnicity attributes of 94% Non-Hispanic and 6% Hispanic. FIG. 2B provides a deeper insight into the community surrounding the POI using the distance radius (r) with combined race attributes of: (a) 80% White; (b) 10% African American (Black); (c) 9% Asian; (d) 1% Native American (AmInd). FIG. 2B also provides combined household attributes of 44% Non-Families and 56% Families as well as combined ethnicity attributes of 88% Non-Hispanic and 12% Hispanic. The deeper insight provided by FIG. 2B provides information about a greater population that is likely to visit the POI enabling the POI to provide products/services that are better suited to the greater population.

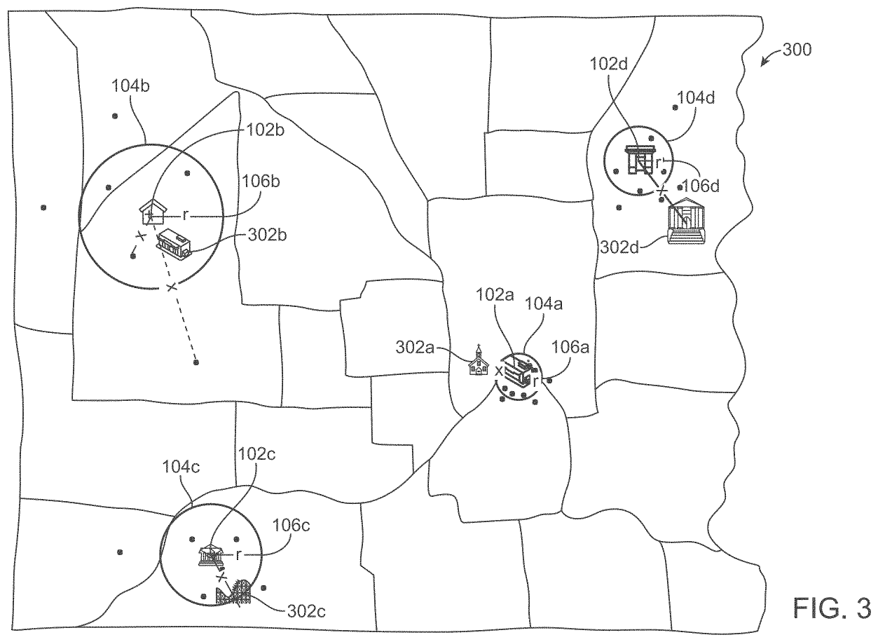

Referring to FIG. 3, a geographical map 300 illustrates the various POIs of FIG. 1, e.g., retail store 102a, hospital 102b, college 102c and gymnasium 102d, along with secondary points of interest, hereafter S-POI, such as a church 302a, a museum 302b, amusement park 302c, and another retail store 302d. As with each of the POIs, each of the S-POIs 302a -302d has a position point on the map 300 that is identified with a unique latitude and longitude. Further, each of the S-POIs 302a-302d can additionally be identified as residing within a specific zip code based on the latitude/longitude. In certain embodiments, a street address of the SMB-POI 302a-302d can alternatively, or additionally, be used to determine the zip code in which the SMB-POI 302a-302d lies. Attributes specific to the respective S-POIs that fall within the respective geographical circles 104a-104d can be combined with the attributes associated with the zip codes of the collective listing for analysis. In certain embodiments, attributes associated with the zip codes of the collective listing can be combined with attributes specific to the respective the POI and/or further combined with attributes specific to the functionality of the respective S-POIs for analysis.

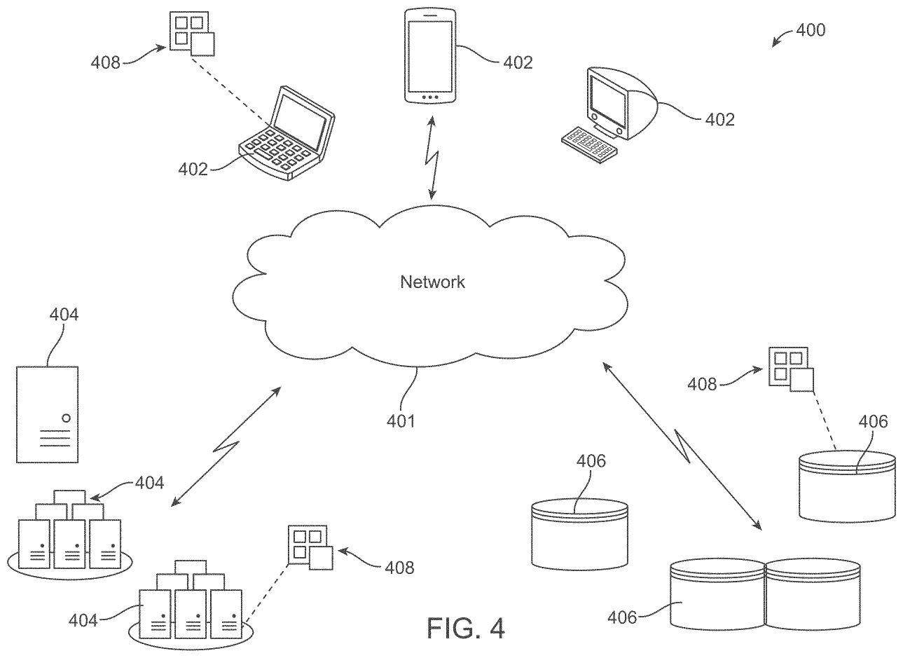

Referring to FIG. 4, an example environment 400 for practicing systems and methods for dynamic data attribution of points of interests (POI) is illustrated. The example environment 400 utilizes a network 401 which connects one or more user computing devices 402 to one or more servers 404 and/or one or more remote mass storage devices 406. A dynamic data attribution application 408 containing programmed instructions for executing dynamic data attribution of POI can be stored on one or more of the user computing devices 402, on the one or more servers 404, on one or more remote data storage devices 406 or on any combination thereof. Other environments for practicing dynamic data attribution of POI are also possible including local application execution and local data storage.

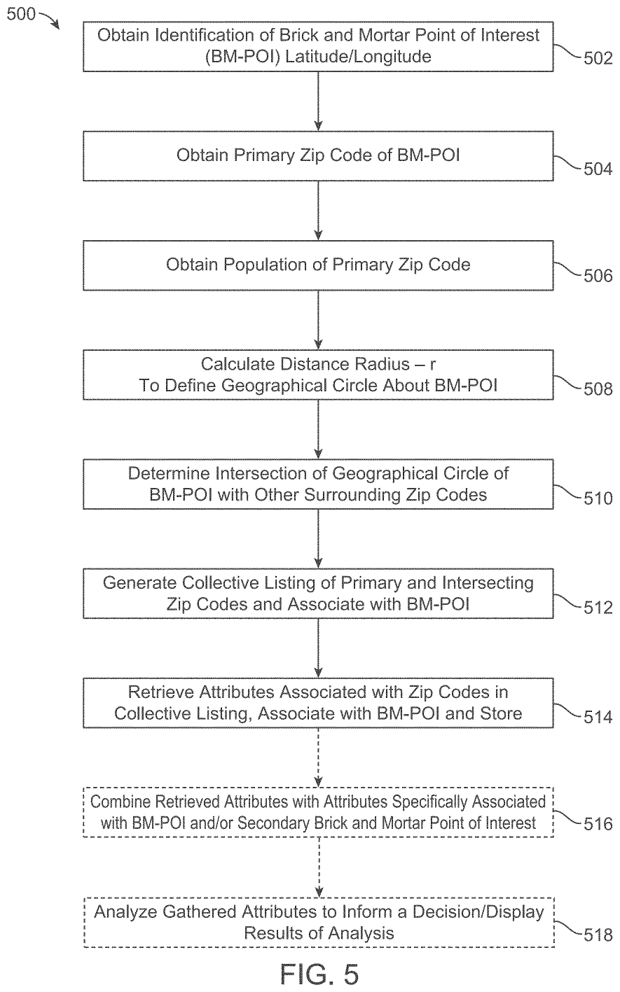

Regarding the environment of FIG. 4, examples of user computing devices 402 include but are not limited to: a mobile telephone; a smart phone; a tablet; a phablet; a smart watch; a wearable computer; a personal computer; a desktop computer; a laptop computer; a gaming device/computer (e.g., Xbox); a television; and the like. Examples of a network 401 include but are not limited to a local area network (LAN), a wide area network (WAN), the Internet, a wired transmission medium, a wireless transmission medium or any combination thereof. Each of the one or more server computing devices 404 includes at least a processing unit and a system memory for executing programmed instructions such as the dynamic data attribution application 408. Each of the one or more remote mass storage devices 406 is capable of persistently storing large amounts of data in a machine-readable format. Examples of a remote mass storage device 406 include but are not limited to hard drives, solid state drives, optical drives, and tape drives. The dynamic data attribution application 408 includes computer-executable instructions that cause a computing device to perform the dynamic data attribution of POI process 500 diagrammed in the flowchart of FIG. 5.

As shown, the dynamic data attribution of POI process 500 includes obtaining an identification of a point of interest. 502. In certain embodiments, the identification comprises a user-entered latitude and longitude. In certain embodiments, an address, building name, or other unique identifier of the POI is utilized by a search engine to obtain a corresponding latitude and longitude for the POI.

A primary zip code, e.g., the zip code in which the POI resides based on the known latitude and longitude of the POI, is then obtained, 504. A population value representative of the number of individuals residing within the primary zip code and the population density is also obtained, 506.

A distance radius (r) to define a geographical circle, e.g., geographical circle 104a, about the POI, which is located at a center of the geographical circle, is then calculated, 508. The distance radius (r) is inversely proportional to the population density value such that the distance radius (r) is smaller for densely populated areas and larger for less densely populated areas. Dependent upon the distance radius (r), the resulting geographical circle may lie entirely within the primary zip code or may intersect with other non-primary zip codes.

Accordingly, the dynamic data attribution of POI process 500 further includes determining whether a latitude and longitude point assigned to a respective zip code is of a distance (x) from the MB-POI that is equal to or less than the determined distance radius (r), e.g., x≤r, 510. In certain embodiments, the distance x is determined using the Haversine formula. The Haversine formula determines the great-circle distance between two points on a sphere (e.g., Earth) given their latitudes and longitudes.

A collective listing that includes the primary zip code and any zip codes determined to intersect with the geographic circle is generated and associated with the MB-POI, 512. Data attributes associated with the primary zip code and intersecting zip codes of the collective listing are retrieved from public or private data stores in local or remote data storage devices, as available, and stored in association with the MB-POI, 514. In certain embodiments, the data attributes associated with the primary and intersecting zip codes have been collected and/or generated by government (e.g., local, state, federal, etc.) bodies/agencies. In certain embodiments, the data attributes include census data.

In certain embodiments, all available associated data attributes that are found are retrieved and stored for subsequent analysis. In certain embodiments, one or more pre-defined types of associated data attributes are retrieved and stored for subsequent analysis. Examples of the types of analysis that can be performed on the retrieved data attributes are described elsewhere within the specification.

In certain embodiments, the dynamic data attribution of POI process 500 additionally includes combining the retrieved data with data attributes specifically associated with the POI and/or data attributes specifically associated with one or more secondary points of interest (S-POI), 516. The combined data is associated with the POI and stored for analysis. In certain embodiments, the S-POI resides within the primary zip code. In certain embodiments, the S-POI resides within one of the interesting zip codes. In certain embodiments, the S-POI is within a pre-defined distance from the POI that may or may not lie within the primary or intersecting zip codes.

In certain embodiments, the dynamic data attribution of POI process 500 additionally includes analyzing the gathered attributes to inform a decision related to products and/or services that are provided at the POI and to display the results of the analysis to a user, 518. In certain embodiments, the gathered attributes are analyzed to inform other decisions of interest.

In example embodiments, decisions of interest may be dependent on the entity represented by the POI. In the case the POI corresponds to a retail location, decisions of interest may include a determination of how various S-POI may affect sales performance at the POI. For example, attributes associated with a sports venue may be attributed to a particular retail location, such as increased tendency to sell rainwear, sports memorabilia, and sportswear, etc. Attributes associated with a beach may be attributed to a further retail location, which may indicate an interest at the retail location nearby of a greater likelihood of sales of sunscreen, sunglasses, etc.

The method described above includes steps occurring in a specific sequence. However, it should be noted that the steps of the method can be performed in any suitable sequence and can include a greater or lesser number of steps than those provided in FIG. 4. Further, the recited steps can additionally, or alternatively, be combined or divided to reduce or increase the number of steps, respectively.

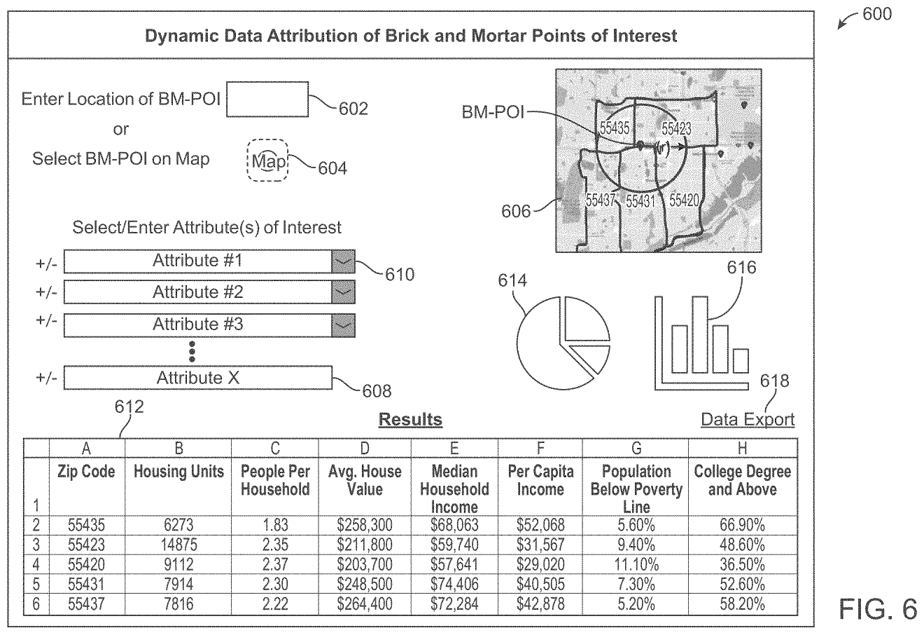

In certain embodiments, inputs and/or outputs of the dynamic data attribution of POI process 500 are facilitated through one or more user-interfaces. One of many possible configurations of a user-interface (UI) 600 is illustrated in FIG. 6 and is provided solely as a non-limiting example. As shown, the UI 600 can include a location field 602 where a user may enter, for example, a latitude/longitude of the POI, a street address of the POI, a zip code of the POI or other identifier that may be used to obtain a zip code and a corresponding population density for the POI from an available information resource/data store (e.g., the Internet, local or remote database, etc.). Alternatively, or additionally, the UI 600 can include a map icon 604 enabling a user to access a map and select a location of the POI on the map from which a zip code can be obtained and used to obtain a corresponding population density. These features of the UI 600 enable completion of steps 502-506 of the process 500.

With the population density identified, a computing device is used to calculate the distance radius (r), determine the intersection of the corresponding geographic circle of the POI with other surrounding zip codes and associate those zip codes with the POI, per process steps 508-512. In certain embodiments, the results of the process steps are reflected in an image such as image 606 of the UI 600. The image 606 includes a map with the distance radius (r) indicated, the geographic circle indicated, location of the POI indicated and zip code areas intersecting with the geographic circle indicated.

In certain embodiments, the UI 600 provides user with the opportunity to manually enter in an attribute field 608 and/or select from one or more drop down menus 610 one or more attributes of interest in association with the POI. A computing device may then retrieve data associated with the one or more attributes of interest for the zip codes intersecting with the geographic circle from one or more information resources/data stores (e.g., the Internet, local or remote databases, etc.) in accordance with process steps 514, 516. Attribute fields and/or drop down menus can also be provided for a secondary POI as appropriate. In certain embodiments, the obtained attribute data can be displayed in the UI 600 in one or more formats of interest (which can be selectable by the user) such as, for example, a table display, 612, a pie chart 614 and/or a bar chart 616.

In certain embodiments, the UI 600 includes a data export option 618, which enables a user to download the attribute data for further data analysis by another program and/or computing device.

Other examples where the dynamic data attribution process described herein can be used include, but are not limited to, restaurant industry applications, real estate applications private equity/venture capital applications, and healthcare applications.

Regarding restaurant industry applications, the dynamic data attribution process can be used, for example, to inform decisions in optimizing food inventory and distribution, inform decisions for menu optimization and optimizing hyperlocal marketing based on the attributes associated with a geographic circle, which is established with the distance radius (r) about the physical location of a restaurant. In this example, attributes of interest can include, but are not limited to: (a) census demographic data (e.g., race, ethnicity, income, population, age/gender, etc.); (b) point of interest location and attribute data (e.g., distance to competitors, to airports, to beaches, to parks, to stadiums, etc.); (c) public health data (e.g., Covid cases/deaths/immunizations, insurance coverage, etc.); (d) economic data (e.g., unemployment, poverty, housing, etc.); (e) restaurant location-specific data (e.g., point of sale (POS), inventory, distribution centers, customer transactions/customer loyalty, orders). From all or a portion of the attributes, correlations between restaurant performance and the attributes can be established to inform future decisions.

Regarding real estate applications, the dynamic data attribution process can be used, for example, to inform decisions in identifying optimal locations for new land development, new restaurants, new retail stores, etc. (note: a location of non-developed land can be used as opposed to a physical location of a point of interest). The dynamic data attribution process can also be used for residential lifestyle scoring to help buyers identify location preferences, for finding the worst homes in the best neighborhoods for house flipping purposes, and for land acquisition comparison analysis. In this example, attributes of interest can include, but are not limited to: (a) census demographic data (e.g., race, ethnicity, income, population, age/gender, etc.); (b) point of interest location and attribute data (e.g., distance to competitors, to airports, to beaches, to parks, to stadiums, etc.); (c) public health data (e.g., Covid cases/deaths/immunizations, insurance coverage, etc.); (d) economic data (e.g., unemployment, poverty, housing, etc.); (e) residential home and/or land records that provide parcel information, size, taxes, plat information and current/past owners; (f) chain/franchise/developer location-specific data including current performance data of business located on the land; and (g) multiple listing service (MLS) information. From all or a portion of the attributes, correlations between land and the attributes can be established to inform future decisions (e.g., provide a personalized, quantifiable score for every latitude and longitude based on local environmental factors affecting real estate).

Regarding private equity/venture capital applications, the dynamic data attribution process can be used, for example, to inform decisions on potential purchases of location-based business (e.g., the dynamic data attribution process can demonstrate areas of strength, weakness, and opportunity for the business) or inform decisions on expanding or closing the location-based business. In this example, attributes of interest can include, but are not limited to: (a) census demographic data (e.g., race, ethnicity, income, population, age/gender, etc.); (b) point of interest location and attribute data (e.g., distance to competitors, to airports, to beaches, to parks, to stadiums, etc.); (c) public health data (e.g., Covid cases/deaths/immunizations, insurance coverage, etc.); (d) economic data (e.g., unemployment, poverty, housing, etc.); (e) location-specific data associated with operation of the location-based business (e.g., point of sale (POS), inventory, distribution centers, customer transactions, customer loyalty, orders, etc.). From all or a portion of the attributes, correlations between the location-based business and the attributes can be established to inform future decisions (e.g., provide a deep dive analysis of chainwide performance at the individual business location level).

Regarding healthcare applications, the dynamic data attribution process can be used, for example, to identify franchise locations for expansion of VIP services and/or to improve a level of healthcare based on a personalized knowledge of the healthcare provider location. In this example, attributes of interest can include, but are not limited to: (a) census demographic data (e.g., race, ethnicity, income, population, age/gender, etc.); (b) point of interest location and attribute data (e.g., distance to competitors, to airports, to beaches, to parks, to stadiums, etc.); (c) public health data (e.g., Covid cases/deaths/immunizations, insurance coverage, etc.); (d) economic data (e.g., unemployment, poverty, housing, etc.); (f) healthcare provider office location-specific data (e.g., performance data, practice offerings, patient transactions, referrals, patient statistics, etc.). From all or a portion of the attributes, correlations between the healthcare provider location and the attributes can be established to inform future decisions (e.g., provide a personalized, quantifiable score for every latitude/longitude based on local environmental factors affecting healthcare).

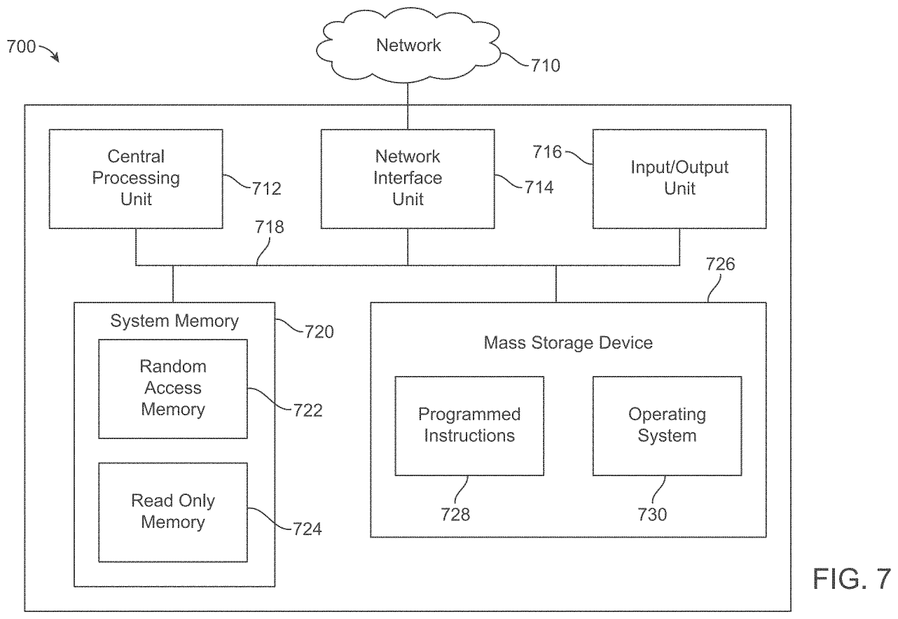

Referring now to FIG. 7, an example block diagram of a computing device 700 is shown that is useable to implement aspects of the environment 400 of FIG. 4 for dynamic data attribution of points of interest. In the example, the computing device 700 includes at least one central processing unit (“CPU”) 712, a system memory 720, and a system bus 718 that couples the system memory 720 to the CPU 712. The system memory 720 includes a random access memory (“RAM”) 722 and a read-only memory (“ROM”) 724. A basic input/output system that contains the basic routines that help to transfer information between elements within the computing device 700, such as during startup, is stored in the ROM 724. The computing device 700 further includes a mass storage device 726 that stores programmed instructions and data.

The mass storage device 726 is connected to the CPU 712 through a mass storage controller (not shown) connected to the system bus 718. The mass storage device 726 and its associated computer-readable storage media provide non-volatile, non-transitory data storage for the computing device 700. Although the description of computer-readable storage media contained herein refers to a mass storage device, such as a hard disk or solid state disk, it should be appreciated by those skilled in the art that computer-readable data storage media can include any available tangible, physical device, or article of manufacture from which the CPU 712 can read data and/or instructions. In certain embodiments, the computer-readable storage media comprises entirely non-transitory media.

Computer-readable storage media includes volatile and non-volatile, removable, and non-removable media implemented in any method or technology for storage of information such as computer-readable programmed instructions (e.g., software), data structures, program modules, or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 700.

According to various embodiments of the present disclosure, the computing device 700 may operate in a networked environment using logical connections to remote network devices through a network 710. The computing device 700 may connect to the network 710 through a network interface unit 714 connected to the system bus 718. It should be appreciated that the network interface unit 714 may also be utilized to connect to other types of networks and remote computing systems. The computing device 700 also includes an input/output unit 716 for receiving and processing input from any number of input devices such as a keyboard, mouse, microphone, camera, touch display screen, or other type of input device. Similarly, the input/output unit 716 may provide output to any number of output devices such as a display screen, a speaker, a printer, or other type of output device.

As mentioned briefly above, the mass storage device 726 and the RAM 722 of the computing device 700 can store programmed instructions and data. The programmed instructions include an operating system 730 suitable for controlling the operation of the computing device 700. The mass storage device 726 and/or the RAM 722 also store programmed instructions 728, that when executed by the CPU 712, cause the computing device 700 to provide the functionality discussed in this document. For example, the mass storage device 726 and/or the RAM 722 can store programmed instructions that, when executed by the CPU 712, cause the computing device 700 to perform the method for dynamic data attribution for points of interest.

Referring to FIGS. 1-7 generally, it is recognized that the present application has several advantages over existing systems for attributing population information to particular locations. For example, while in traditional analyses, a zip code in which a point of interest is located may be used to determine demographic, secondary point of interest, or similar information, such analyses may be highly inaccurate because the point of interest may not be centrally located within the zip code, may not draw visitors (e.g., customers) from that same zip code, or there may be other reasons why the zip code demographics are not representative of the point of interest. By more accurately identifying the particular demographics that may affect visits to a point of interest, and more accurately identifying other points of interest that may affect visits to an original point of interest, accuracy of prediction and therefore decision making may be improved.

Although specific aspects are described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed:

1. A computer-implemented method for data attribution, comprising:
obtaining a latitude and longitude of a first point associated with a physical location of a point of interest;
determining a first zip code in which the first point lies determining a population density of the first zip code;
establishing a geographical circle about the point of interest with the first point located at a center of the geographical circle, the geographical circle having a distance radius, measured relative to the center, that is inversely proportional to the population density of the first zip code;
determining a second zip code with which the geographical circle intersects;
obtaining data attributes associated with the first and second zip codes;
associating the data attributes with the point of interest; and
displaying the associated data attributes via a user-interface.

2. The computer-implemented method of claim 1, wherein determining the second zip code with which the geographical circle intersects includes:
obtaining a latitude and longitude of a second point, the second point being at a physical location previously established as an identifying location of the second zip code;
determining a distance between the between the first point and the second point; and
determining that the distance less than or equal to the distance radius.

3. The computer-implemented method of claim 2, wherein determining the distance between the first point and the second point includes utilizing the Haversine distance formula.

4. The computer-implemented method of claim 1, wherein the data attributes associated with the first and second zip codes are stored in a publicly-accessible database.

5. The computer-implemented method of claim 4, wherein data attributes of the publicly accessible database have been generated from census data obtained by a state or country in which the point of interest lies.

6. The computer-implemented method of claim 1, further comprising:
obtaining data attributes specific to a functionality of the point of interest;
combining and storing the data attributes specific to the functionality of the point of interest with the data attributes associated with the first and second zip codes.

7. The computer-implemented method of claim 6, further comprising:
analyzing the combined data attributes to inform a decision on offering a certain product or service at the point of interest.

8. The computer-implemented method of claim 1, further comprising:
obtaining a location of a new point associated with a physical location of a second point of interest, the new point being different from the first point;
determining a new zip code in which the new point lies;
obtaining data attributes associated with the new zip code; and
combining and storing the data attributes associated with the new zip code with the data attributes associated with the first and second zip codes.

9. The computer-implemented method of claim 8, wherein the physical location of the second point of interest is within the geographical circle.

10. The computer-implemented method of claim 8, wherein the physical location of the second point of interest is outside the geographical circle.

11. The computer-implemented method of claim 8, further comprising:
analyzing the combined data attributes to inform a decision on offering a certain product or service at the point of interest.

12. A computer-implemented method for data attribution, comprising:
defining a geographical area equidistantly about a physical location of a point of interest, the physical location associated with a first zip code;
determining that the geographical area intersects with a physical location associated with a second zip code that is different from the first zip code;
obtaining data attributes associated with the first and second zip codes; and
associating the data attributes with the point of interest.

13. The computer-implemented method of claim 12, wherein geographical area is inversely proportional to a population density associated with first zip code.

14. The computer-implemented method of claim 12, further comprising:
determining that the physical location is associated with the first zip code based on a street address of the physical location.

15. The computer-implemented method of claim 12, further comprising:
determining that the physical location is associated with the first zip code based on a latitude and longitude associated with the physical location of the point of interest.

16. The computer-implemented method of claim 12, wherein the second zip code comprises a plurality of second zip codes.

17. The computer-implemented method of claim 12, wherein determining that the geographical area intersects with the physical location associated with the second zip code includes:
determining a distance between the physical location of the point of interest and the physical location of the second zip code; and
determining that the distance falls within the defined geographical area.

18. The computer-implemented method of claim 17, wherein determining the distance between the physical location of the point of interest and the physical location of the second zip code is based on a latitude and longitude associated with the physical location of the point of interest and based on a latitude and longitude associated with the physical location of the second zip code.

19. A computer-implemented method for data attribution, comprising:
defining a geographical area equidistantly about a physical location of a point of interest, the physical location associated with a first zip code;
determining that the geographical area intersects with a physical location associated with a second zip code that is different from the first zip code;
obtaining first data attributes associated with the first and second zip codes;
obtaining second data attributes associated with a functionality of the point of interest;
combining the first and second data attributes;
associating the combined first and second data attributes with the point of interest; and
analyzing the combined first and second data attributes to inform a decision on offering a product or service at the point of interest.

20. The computer-implemented method of claim 19, wherein the second data attributes associated with the functionality of the point of interest includes sales data of products or services previously offered at the point of interest.
